(19) United States
(12) Patent Application Publication
(10) Pub. No.: US 2014/0179450 A1
(43) Pub. Date: Jun. 26, 2014

(54) METHOD OF MANUFACTURING A SHAFT FOR A PNEUMATIC TOOL AND SHAFT MADE BY THE SAME

(71) Applicant: AIRBOSS AIR TOOL CO., LTD., Taichung City (TW)

(72) Inventor: Hsin-He Chang, Taichung City (TW)

(73) Assignee: AIRBOSS AIR TOOL CO., LTD., Taichung City (TW)

(21) Appl. No.: 13/727,586

(22) Filed: Dec. 26, 2012

(51) Int. Cl. B23P 15/00; F16C 3/02; B23P 17/00

(52) U.S. Cl. CPC B23P 15/00; B23P 17/00; F16C 3/023
USPC 464/183; 29/527.5; 29/527.6

(57) ABSTRACT

A method of manufacturing a shaft of a pneumatic tool has steps of casting, friction welding and processing. In the step of casting, a hollow section of a first segment and a second segment are respectively prepared. In the step of friction welding, the second segment is connected with a second end surface of the hollow section of the first segment by a friction welding process to form a work-in-process shaft. In the step of processing, an outer surface of the work-in-process shaft is processed to form a shaft. The hollow section is casted to form through holes therein. Accordingly, the weight of the shaft is reduced, the shaft becomes light and the material cost of the shaft is diminished.

### BACKGROUND OF THE INVENTION

1. Field of the Invention

The present invention relates to a method of manufacturing a shaft for a pneumatic tool and a shaft made by the same, and more particularly to a method of manufacturing a shaft for a pneumatic tool to reduce the weight and material cost of the shaft.

2. Description of Related Art

With reference to FIG. 13, a conventional shaft 90 for a pneumatic tool has a first end 91 and a second end 92 opposite to the first end 91. The first end 91 of the shaft 90 can be connected with different sleeves or tool bits. The second end 92 of the shaft 90 can be inserted into a main body of a pneumatic tool. The shaft 90 can be rotated to drill or crack an object when the pneumatic tool is operated by a user.

Because the shaft 90 has to sustain strong torque, the shaft 90 is made of a solid metal stick manufactured with procedures such as heat-treating and cutting. Accordingly, the shaft 90 has a high structural strength. However, the shaft 90 is a solid metal and reaches up to 3 to 4 kilograms in weight, which is quite a burden for a user holding the shaft 90. Moreover, the material cost of the shaft 90 is also considerable.

The conventional method of manufacturing the shaft 90 for a pneumatic tool cannot reduce the weight of the shaft 90 with said drawbacks.

To overcome the shortcomings, the present invention tends to provide a method of manufacturing a shaft for a pneumatic tool and a shaft made by the same to mitigate the aforementioned problems.

### SUMMARY OF THE INVENTION

The main objective of the invention is to provide a method of manufacturing a shaft for a pneumatic tool and a shaft made by the same to reduce the weight and material cost of the shaft.

A method of manufacturing a shaft of a pneumatic tool comprises steps of casting, friction welding and processing. In the step of casting, a hollow section of a first segment is casted and a second segment is prepared. In the step of friction welding, the second segment is connected onto a second end surface of the hollow section of the first segment by a friction welding process to form a work-in-process shaft. In the step of processing, an outer surface of the work-in-process shaft is processed to form a shaft. The hollow section is casted to form through holes therein. Accordingly, the weight of the shaft is reduced, the shaft becomes light and the material cost of the shaft is diminished.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a first embodiment of a method of manufacturing a shaft for a pneumatic tool in accordance with the present invention;

FIG. 2 is an exploded cross sectional side view of a first embodiment of a shaft for a pneumatic tool in accordance with the present invention;

FIG. 3 is a cross sectional side view of the shaft in FIG. 2;

FIG. 4 is an enlarged cross sectional top view of the shaft in FIG. 2;

FIG. 5 is a perspective view of the shaft in FIG. 3;

FIG. 6 is an operational perspective view of the shaft in FIG. 3;

FIG. 7 is an exploded cross sectional side view of a shaft manufactured by a second embodiment of the method in accordance with the present invention;

FIG. 8 is an exploded cross sectional side view of a shaft manufactured by a third embodiment of the method in accordance with the present invention;

FIG. 9 is a cross sectional top view of a second embodiment of a hollow section of the shaft for a pneumatic tool in accordance with the present invention;

FIG. 10 is a cross sectional top view of a third embodiment of a hollow section of the shaft for a pneumatic tool in accordance with the present invention;

FIG. 11 is a cross sectional top view of a fourth embodiment of a hollow section of the shaft for a pneumatic tool in accordance with the present invention;

FIG. 12 is a cross sectional top view of a fifth embodiment of a hollow section of the shaft for a pneumatic tool in accordance with the present invention; and

FIG. 13 is a cross sectional side view of a conventional shaft for a pneumatic tool in accordance with the prior art.

### DETAILED DESCRIPTION OF PREFERRED EMBODIMENT

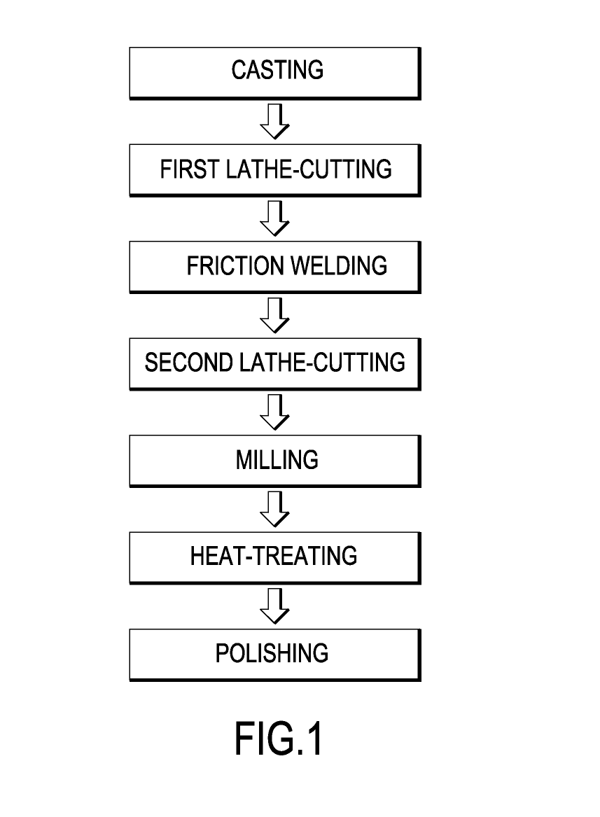

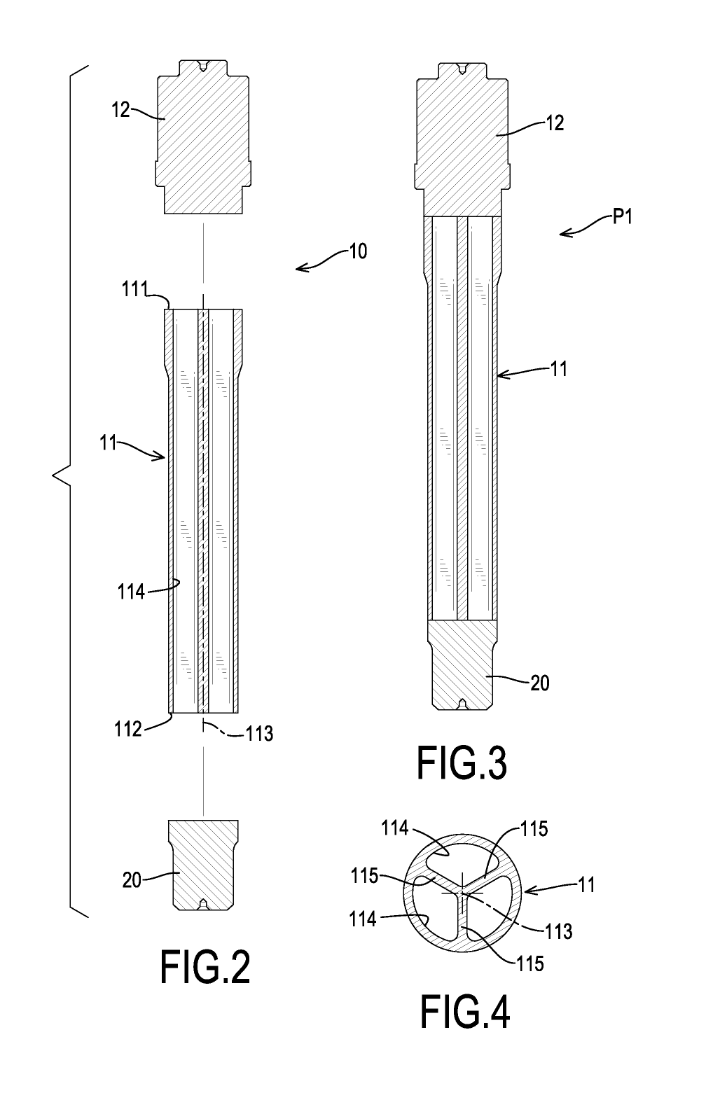

With reference to FIGS. 1 to 4, a first embodiment of a method of manufacturing a shaft for a pneumatic tool in accordance with the present invention comprises the following steps.

A. Casting:

A first segment 10 and a second segment 20 are prepared.

The first segment 10 has a hollow section 11 and a connecting section 12. he hollow section 11 is elongated, casted and has a first end surface 111, a second end surface 112 and an axis 113. The second end surface 112 is opposite to the first end surface 111 of the hollow section 11.

The connecting section 12 and the second segment 20 are respectively a solid chunk.

Preferably, the hollow section 11, the connecting section 12 and the second segment 20 are three individual components and are respectively casted.

Alternatively, the connecting section 12 and the second segment 20 may not be casted. The present invention does not limit how the connecting section 12 and the second segment 20 are manufactured.

B. First Lathe-Cutting:

Outer surfaces of the hollow section 11, the connecting section 12 and the second segment 20 are respectively lathe-cut into desired shapes.

C. Friction Welding:

The second segment 20 is connected with the second end surface 112 of the hollow section 11 by a friction welding process, and the connecting section 12 is connected with the first end surface 111 of the hollow section 11 by a friction welding process to form a work-in-process shaft P 1.

A subsequent step of processing has the following sub-steps of:

D. Second Lathe-Cutting:

The outer surface of the work-in-process shaft P1 is lathe-cut into a desired shape.

E. Milling:

The outer surface of the work-in-process shaft P1 is milled into a desired shape.

F. Heat-Treating:

The work-in-process shaft P1 is heat-treated to increase strength of the work-in-process shaft P1.

G. Polishing:

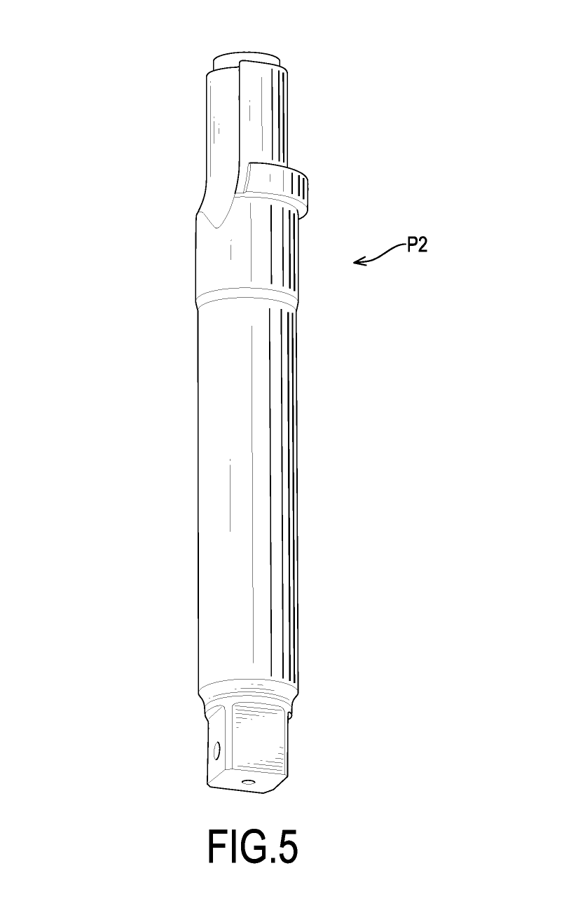

The outer surface of the work-in-process shaft P1 is polished for smoothing to form a shaft P2, as shown in FIG. 5.

In addition, the steps of first lathe-cutting, second lathe-cutting, milling, heat-treating and polishing may be conventional and detailed description is omitted.

With reference to FIGS. 3 to 5, a first embodiment of the shaft P2 manufactured by the first embodiment of the method of manufacturing a shaft for a pneumatic tool in accordance with the present invention has the first segment 10 and the second segment 20. The structure of the hollow section 11 of the shaft P2 is further described.

The hollow section 11 has at least three through holes 114 and at least three ribs 115. The at least three through holes 114 are arranged at intervals. Each through hole 114 is formed through the hollow section 11, is formed through the first end surface 111 and the second end surface 112, and is parallel to the axis 113 of the hollow section 11. A number of the at least three ribs 115 is the same as that of the at least three through holes 114. The at least three ribs 115 are formed between the at least three through holes 114, and are arranged at intervals.

Preferably, the number of the through holes 114 is three, and the number of the ribs 115 is also three. The ribs 115 are arranged radially relative to the axis 113 of the hollow section 11, and are evenly spaced.

The hollow section 11 is casted to form the through holes 114. Accordingly, the weight of the shaft P2 is reduced down to two-thirds of a weight of the conventional shaft 90. Consequently, the shaft P2 becomes light and the material cost of the shaft P2 is reduced.

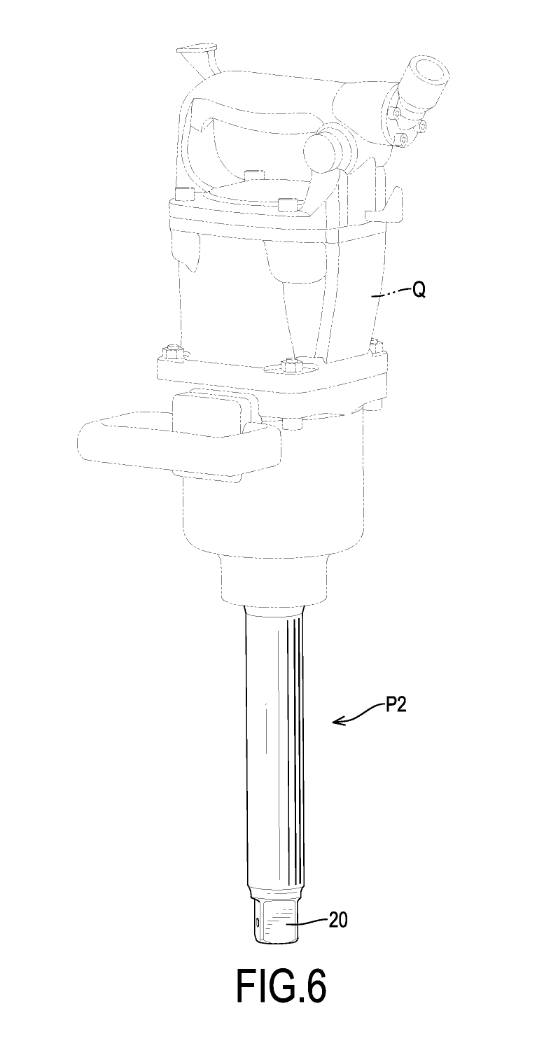

With further reference to FIG. 6, the connecting section 12 of the shaft P2 is inserted into a main body Q of a pneumatic tool, and the second segment 20 of the shaft P2 is capable of being connected with different sleeves or tool bits. Alternatively, the connecting section 12 may be processed to fit with different sleeves or tool bits. The second segment 20 may be processed to be inserted into the main body Q of the pneumatic tool. The present invention does not limit that the connecting section 12 has to be connected with the main body Q of the pneumatic tool.

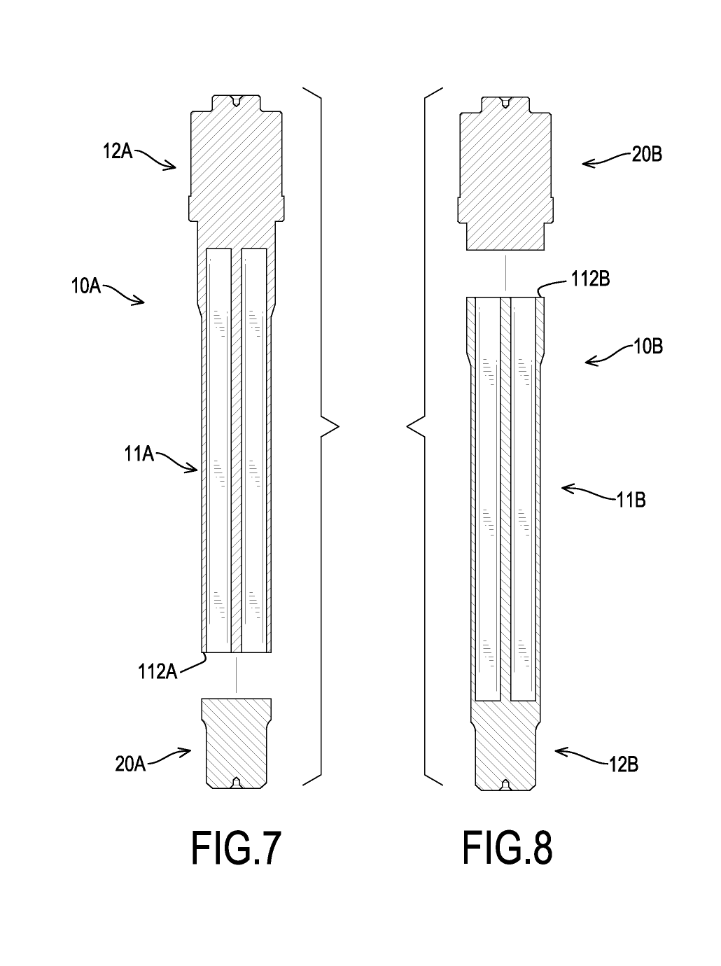

With reference to FIG. 7, a second embodiment of the method of manufacturing a shaft for a pneumatic tool in accordance with the present invention is substantially the same as the first embodiment.

In the step of casting, the first segment 10A and the second segment 20A are respectively casted. The hollow section 11A of the first segment 10A and the connecting section 12A are integrally casted. In the step of friction welding, the second segment 20A is then connected with the second end surface 112A of the hollow section 11A by a friction welding process. The present invention does not limit the number of the casted components in the step of casting.

With reference to FIG. 8, a third embodiment of the method of manufacturing a shaft for a pneumatic tool in accordance with the present invention is substantially the same as the first embodiment.

In the step of casting, the first segment 10B and the second segment 20B are respectively casted. The hollow section 11B of the first segment 10B and the connecting section 12B are integrally casted. In the step of friction welding, the second segment 20B is then connected with the second end surface 112B of the hollow section 11B by a friction welding process. The connecting section 12B is processed to fit with different sleeves or tool bits. The second segment 20B is processed to be inserted into the main body Q of the pneumatic tool.

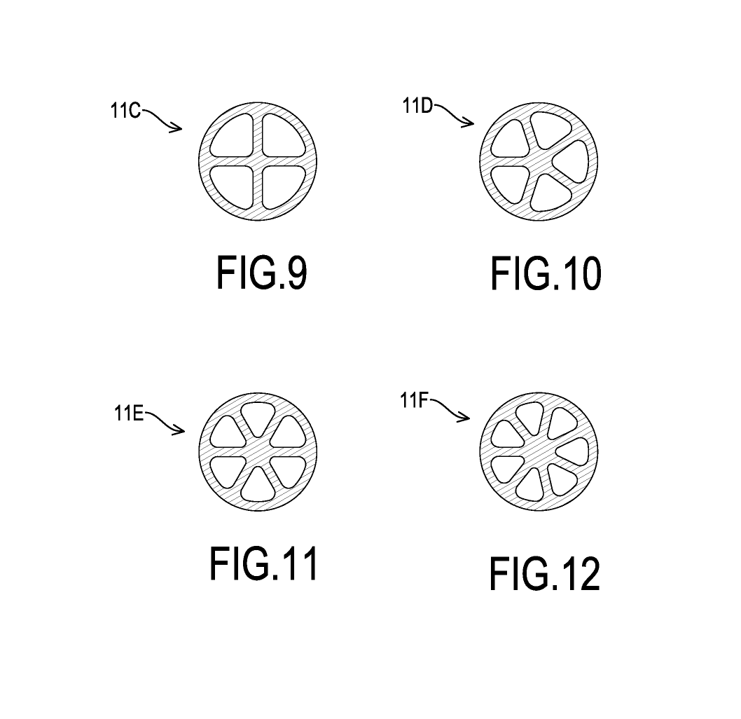

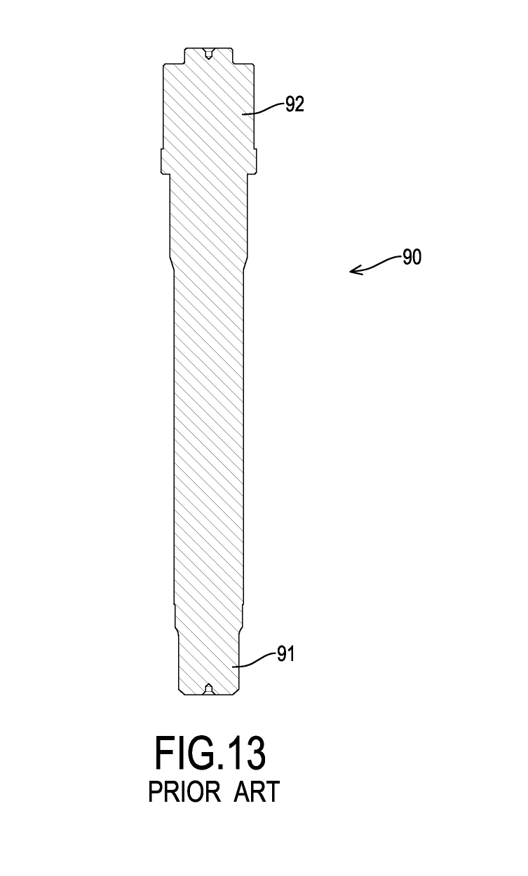

With reference to FIGS. 9 to 12, second, third, fourth and fifth embodiments of the shaft for a pneumatic tool in accordance with the present invention are substantially the same as the first embodiment of the shaft P2.

The numbers of the ribs 115 of the hollow sections 11C, 11D, 11E, 11F are respectively four, five, six and seven. The number of the ribs 115 in the present invention ranges from 3 to 8. The weight of the shaft P2 is light if the amount of the ribs 115 is three. Furthermore, the structural strength of the shaft P2 is sufficient if the amount of the ribs 115 is eight.

From the above description, it is noted that the present invention has the following advantages:

1. Reduced Weight and Material Cost:

The hollow section 11,11A,11B,11C,11D,11E,11F is casted to form the through holes 114. Consequently, the weight of the shaft P2 is reduced, the shaft P2 becomes light and the material cost of the shaft P2 is diminished.

2. Easy Hold:

As the shaft P2 becomes light, the pneumatic tool is held with ease for prolonged operation.

3. Enhanced Connection Between the First Segment 10 and the Second Segment 20 of the First Embodiment of the Method:

Because the second segment 20 and the connecting section 12 in the first embodiment of the method are respectively connected with the hollow section 11 by friction welding processes, the connection among the hollow section 11, the connecting section 12 and the second segment 20 is enhanced compared to the second and third embodiments of the method. This is because a total friction-welded connecting area in the first embodiment, which is the sum of the first end surface 111 and the second end surface 112, is larger than those in the second and third embodiments of the method, and the connection in the first embodiment of the method is further enhanced to sustain strong torque.

4. Enhanced Inner Structural Strength:

The hollow section 11,11A,11B,11C,11D,11E,11F has the ribs 115 corresponding to the through holes 14. The ribs 115 can also provide sufficient structural strength even though the weight of the shaft P2 is reduced.

Moreover, the ribs 115 enlarge the total friction-welded connecting area, which is the sum of the first end surface 111 and the second end surface 112, and the connection is further enhanced to sustain stronger torque.

5. Reduction of Vibration:

In operation, vibrations pass through the second segment 20,20A,20B, the hollow section 11,11A,11B,11C,11D,11E,11F and the connecting section 12,12A,12B to impact on hands of a user. As the hollow section 11,11A,11B,11C,11D,11E,11F is hollow, the hollow section 11,11A,11B,11C,11D,11E,11F can effectively mitigate the passing of the vibrations.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of manufacturing a shaft for a pneumatic tool comprising steps of:
casting, wherein a first segment and a second segment are prepared;
the first segment has
an elongated and casted hollow section having a first end surface and a second end surface opposite to the first end surface; and
a connecting section being a solid chunk; and
the second segment is a solid chunk;
friction welding, wherein the second segment is connected with the second end surface of the hollow section by a friction welding process to form a work-in-process shaft; and
processing, wherein the work-in-process shaft is processed to form a shaft.

2. The method of manufacturing a shaft for a pneumatic tool as claimed in claim 1, wherein in the step of casting, the connecting section is casted, and the connecting section and the hollow section are respectively prepared; and
in the step of friction welding, the connecting section is connected with the first end surface of the hollow section by a friction welding process.

3. The method of manufacturing a shaft for a pneumatic tool as claimed in claim 1, wherein in the step of casting, the first segment is casted, and the hollow section and the connecting section are integrally casted.

4. The method of manufacturing a shaft for a pneumatic tool as claimed in claim 1 further comprising a step of first lathe-cutting between the step of casting and the step of friction welding; wherein
in the step of first lathe-cutting, outer surfaces of the first segment and the second segment are respectively lathe-cut into desired shapes.

5. The method of manufacturing a shaft for a pneumatic tool as claimed in claim 2 further comprising a step of first lathe-cutting between the step of casting and the step of friction welding; wherein
in the step of first lathe-cutting, outer surfaces of the first segment and the second segment are respectively lathe-cut into desired shapes.

6. The method of manufacturing a shaft for a pneumatic tool as claimed in claim 3 further comprising a step of first lathe-cutting between the step of casting and the step of friction welding; wherein
in the step of first lathe-cutting, outer surfaces of the first segment and the second segment are respectively lathe-cut into desired shapes.

7. The method of manufacturing a shaft for a pneumatic tool as claimed in claim 4, wherein the step of processing comprises sub-steps of:
second lathe-cutting, wherein the outer surface of the work-in-process shaft is lathe-cut to a desired shape;
milling, wherein the outer surface of the work-in-process shaft is milled to a desired shape;
heat-treating, wherein the work-in-process shaft is heat-treated to increase strength of the work-in-process shaft; and
polishing, wherein the outer surface of the work-in-process shaft is polished for smoothing to form the shaft.

8. The method of manufacturing a shaft for a pneumatic tool as claimed in claim 5, wherein the step of processing comprises sub-steps of:
second lathe-cutting, wherein the outer surface of the work-in-process shaft is lathe-cut into a desired shape;
milling, wherein the outer surface of the work-in-process shaft is milled into a desired shape;
heat-treating, wherein the work-in-process shaft is heat-treated to increase strength of the work-in-process shaft; and
polishing, wherein the outer surface of the work-in-process shaft is polished for smoothing to form the shaft.

9. The method of manufacturing a shaft for a pneumatic tool as claimed in claim 6, wherein the step of processing comprises sub-steps of:
second lathe-cutting, wherein the outer surface of the work-in-process shaft is lathe-cut into a desired shape;
milling, wherein the outer surface of the work-in-process shaft is milled into a desired shape;
heat-treating, wherein the work-in-process shaft is heat-treated to increase strength of the work-in-process shaft; and
polishing, wherein the outer surface of the work-in-process shaft is polished for smoothing to form the shaft.

10. A shaft for a pneumatic tool comprising:
a metallic first segment having
an elongated hollow section having
a first end surface;
a second end surface opposite to the first end surface of the hollow section;
an axis;
at least three through holes arranged at intervals, each through hole formed through the hollow section, formed through the first end surface and the second end surface, and being parallel to the axis of the hollow section; and
at least three ribs formed between the at least three through holes and arranged at intervals, wherein a number of the at least three ribs being same as that of the at least three through holes; and
a connecting section being a solid chunk and integrally connected with the first end surface of the hollow section; and
a metallic second segment being a solid chunk and integrally connected with the second end surface of the hollow section by a friction welding process.

11. The shaft for a pneumatic tool as claimed in claim 10, wherein the number of the ribs of the hollow section ranges from 3 to 8.

12. The shaft for a pneumatic tool as claimed in claim 10, wherein the ribs of the hollow section are arranged radially relative to the axis of the hollow section, and are evenly spaced.

13. The shaft for a pneumatic tool as claimed in claim 11, wherein the ribs of the hollow section are arranged radially relative to the axis of the hollow section, and are evenly spaced.
